(19) United States
(12) Patent Application Publication
(10) Pub. No.: US 2013/0247057 A1
(43) Pub. Date: Sep. 19, 2013

(54) MULTI-TASK PROCESSING APPARATUS

(71) Applicant: ROHM CO., LTD., Kyoto (JP)

(72) Inventors: Yoshikazu Fujimori, Kyoto (JP); Hiromitsu Kimura, Kyoto (JP)

(73) Assignee: Rohm Co., Ltd., Kyoto (JP)

(21) Appl. No.: 13/796,197

(22) Filed: Mar. 12, 2013

(30) Foreign Application Priority Data
Mar. 13, 2012 (JP) 2012-55285

(51) Int. Cl. G06F 9/48

(52) U.S. Cl. CPC G06F 9/4806
USPC 718/102

(57) ABSTRACT

A multi-task processing apparatus includes a sequencer for switching and processing multiple task data; a memory for storing the task data, wherein the memory stores/reads the task data between a volatile memory cell and a plurality of associated non-volatile memory cells when the task data is switched.

### CROSS-REFERENCE TO RELATED APPLICATION

This application is based upon and claims the benefit of priority from Japanese Patent Application No. 2012-055285, filed on Mar. 13, 2012, the entire contents of which are incorporated herein by reference.

### TECHNICAL FIELD

The present disclosure relates to a multi-task processing apparatus that switches and processes a plurality of task data.

### BACKGROUND

Conventionally, a static random access memory (SRAM) enabling high speed data transmission has been widely used in computer-related fields. In addition, as illustrated in FIG. 8, a non-volatile SRAM 300 capable of keeping data in a non-volatile manner by combining an SRAM 301 and a ferroelectric RAM (FeRAM) 302 has also been proposed in recent years.

However, the non-volatile SRAM 300 in FIG. 8 mainly aims to keep data when power supply is shut off, and allows only one kind of task data to be delivered from the volatile SRAM 301 to the non-volatile FeRAM 302. Thus, the non-volatile SRAM 300 in FIG. 8 cannot cope with recent multi-task processing.

Moreover, the related art arbitrarily changes configuration information of circuits such as a field programmable gate array (FPGA) merely by using the non-volatile SRAM, but has no consideration for multi-task processing.

Also, as a countermeasure of multi-task processing, there is known a configuration where an SRAM 400 and a plurality of associated FeRAMs 500 (or flashes) are connected to a common bus 600, and when task switching occurs, data transmission between the SRAM 400 and the FeRAMs 500 (rewrite of task data stored in the SRAM 400) is performed via the bus 600. In such a configuration, however, since the task switching takes a long period of time, it is not appropriate as a countermeasure of multi-task processing.

### SUMMARY

The present disclosure provides some embodiments of a multi-task processing apparatus capable of quickly switching the contents of task data, while maintaining the task data in a non-volatile manner.

According to one aspect of the present disclosure, provided is a multi-task processing apparatus, including: a sequencer configured to switch and process multiple task data; a memory configured to store the task data, wherein the memory is configured to store/read the task data between a volatile memory cell and a plurality of associated non-volatile memory cells when the task data is switched.

In some embodiments, the memory includes a plurality of pairs of the volatile memory cell and the plurality of associated non-volatile memory cells.

In some embodiments, the memory is configured to return the volatile memory cell to a state before power is shut off, after the power is supplied.

In the multi-task processing apparatus, the volatile memory cell is a static random access memory (SRAM), and the non-volatile memory cells are ferroelectric RAMS (FeRAMs).

In some embodiments, the SRAM includes first and second inverters connected in a loop shape; a first switch connected between the first and second inverters and a bit line; and a second switch connected between the first and second inverters and an inverted bit line.

In some embodiments, the FeRAM includes first and second ferroelectric capacitors connected to a common plate line; a third switch connected between the first ferroelectric capacitor and the bit line; and a fourth switch connected between the second ferroelectric capacitor and the inverted bit line.

In some embodiments, the SRAM is integrated into a volatile block, and the FeRAM is integrated into a non-volatile block.

In some embodiments, the FeRAM includes first and second ferroelectric capacitors connected to a common plate line; a third switch connected between the first ferroelectric capacitor and the first and second inverters; and a fourth switch connected between the second ferroelectric capacitor and the first and second inverters.

In some embodiments, the SRAM and the FeRAMs associated with each other are integrated into a memory cell block.

In some embodiments, the sequencer is a central processing unit.

### BRIEF DESCRIPTION OF THE DRAWINGS

FIG. 1 is a block diagram illustrating one configuration example of a multi-task processing apparatus according to some embodiments.

FIG. 2 is a timing chart illustrating one example of a task-switching sequence.

FIG. 3 is a circuit diagram illustrating a first configuration example of a non-volatile SRAM 20.

FIG. 4 is a timing chart illustrating a first control example of the non-volatile SRAM 20.

FIG. 5 is a circuit diagram illustrating a second configuration example of the non-volatile SRAM 20.

FIG. 6 is a timing chart illustrating a second control example of the non-volatile SRAM 20.

FIG. 7 is an appearance view illustrating one configuration example of a desk-top computer on which the non-volatile SRAM is mounted.

FIG. 8 is a block diagram illustrating one example of a related art non-volatile SRAM.

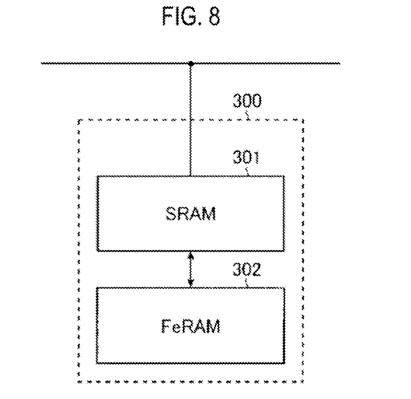

### DETAILED DESCRIPTION

Various embodiments of the present disclosure will now be described in detail with reference to the drawings.

### <Multi-Task Processing Apparatus>

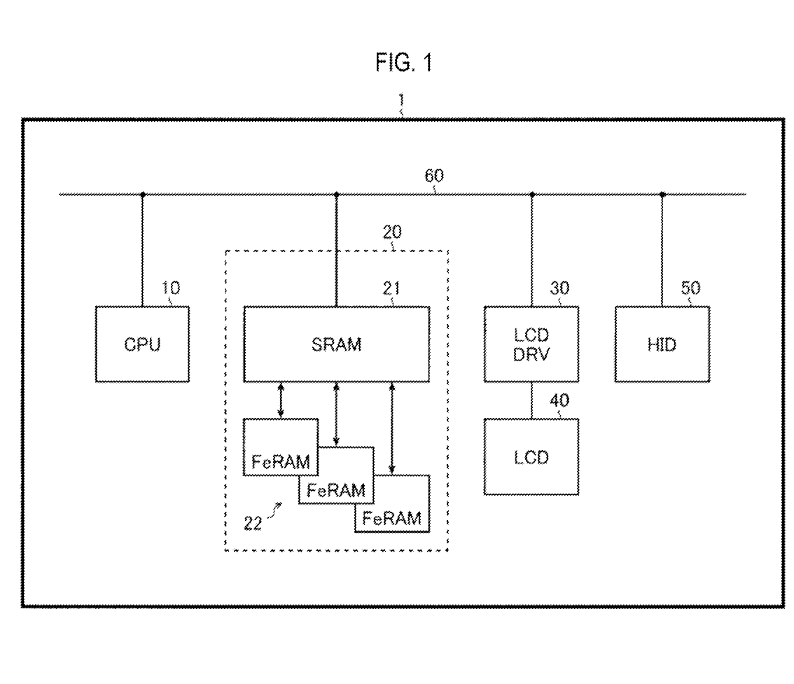

FIG. 1 is a block diagram illustrating one configuration example of a multi-task processing apparatus according to some embodiments. A multi-task processing apparatus 1 includes a sequencer 10, a non-volatile SRAM 20, a liquid crystal display driver 30, a human interface device 50, and a bus 60.

The sequencer 10 has a function of switching multiple task data to execute multi-task processing. As the sequencer 10, a central processing unit (CPU), a digital signal processor (DSP), or the like may be properly used.

The non-volatile SRAM 20 is a semiconductor storage device for storing the task data handled by the sequencer 10, and includes a plurality of pairs of a volatile memory cell (SRAM) 21 and a plurality of associated non-volatile memory cells (FeRAMs) 22 in an array shape.

The liquid crystal display driver 30 generates a drive signal (a video signal or a scan signal) for the liquid crystal display 40 according to an instruction from the sequencer 10.

The liquid crystal display 40 outputs a video signal based on the drive signal from the liquid crystal display driver 30.

The human interface device 50 is a device for receiving operator's manipulations. For example, the human interface device 50 corresponds to a keyboard or a mouse in a PC, or a button or a touch panel in a smart phone or tablet.

The bus 60 is a common signal transmission path to which the sequencer 10, the non-volatile SRAM 20, the liquid crystal display driver 30, and the human interface device 50 are connected.

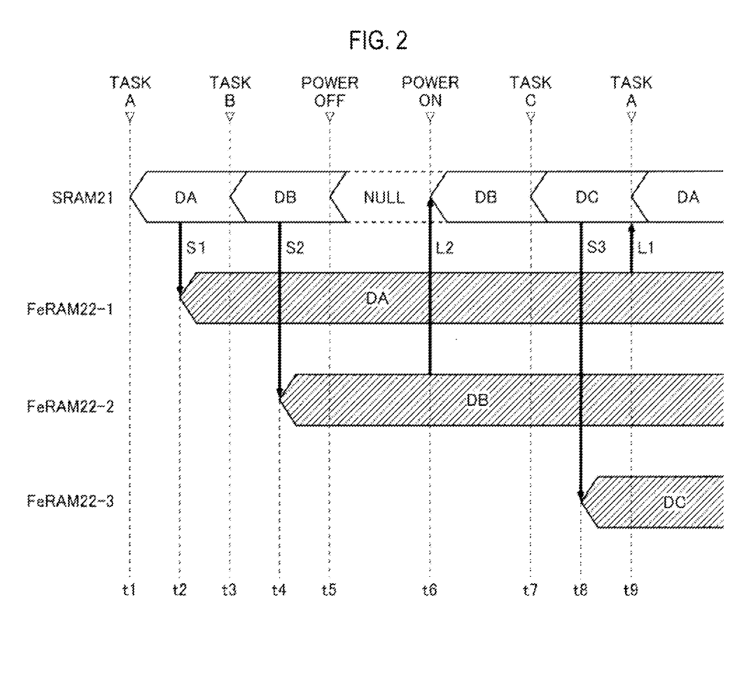

FIG. 2 is a timing chart illustrating one example of a task-switching sequence executed by the multi-task processing apparatus 1. Sequentially from top to bottom, the contents stored in the SRAM 21 and the FeRAMs 22-1 to 22-3 are illustrated. Meanwhile, in FIG. 2, it is assumed that time passes in the order of times t1 to t9.

At time t1, when the task of the sequencer 10 is switched to processing A, task data DA (PICTURE “A”) for executing the processing A is written into the SRAM 21.

Then, at time t2, the task data DA in the SRAM 21 is stored in the FeRAM 22-1 (see arrow S1).

At time t3, when the task of the sequencer 10 is switched from the processing A to processing B, task data DB (PICTURE “B”) for executing the processing B is overwritten into the SRAM 21. At this point, the task data DA in the SRAM 21 is discarded, but the task data DA in the FeRAM 22-1 is kept.

Then, at time t4, the task data DB in the SRAM 21 is stored in the FeRAM 22-2 (see arrow S2).

At time t5, when power supply to the multi-task processing apparatus 1 is shut off, the task data DB in the SRAM 21 is lost. On the other hand, the task data DA in the FeRAM 22-1 and the task data DB in the FeRAM 22-2 are all kept in a non-volatile manner.

At time t6, when the power is supplied to the multi-task processing apparatus 1, the data DB in the FeRAM 22-2 is read out to the SRAM 21 (see arrow L2). Therefore, since the non-volatile SRAM 20 is restored to a previous state before the power is shut off, the processing B can be continuously executed after the power is supplied. However, in order to keep the task of the sequencer 10 without any disconnection before and after the power-off, the data in the non-volatile SRAM 20 as well as data in a register or cache incorporated in the sequencer 10 should be stored in a non-volatile manner when necessary.

At time t7, when the task of the sequencer 10 is switched from the processing B to processing C, task data DC (PICTURE “C”) for executing the processing C is overwritten into the SRAM 21. At this point, the task data DB in the SRAM 21 is discarded, but the task data DB in the FeRAM 22-2 is kept.

Then, at time t8, the task data DC in the SRAM 21 is stored in the FeRAM 22-3 (see arrow S3).

At time t9, when the task of the sequencer 10 is switched back from the processing C to the processing A, the task data DA in the FeRAM 22-1 is read out to the SRAM 21 (see arrow L1). At this point, the task data DC in the SRAM 21 is discarded, but the task data DC in the FeRAM 22-3 is kept.

In this manner, the single SRAM 21 is associated with the plurality of FeRAMs 22-1 to 22-3 and the storing/reading of the task data are performed between the SRAM 21 and the FeRAMs 22-1 to 22-3 when the task of the sequencer 10 is switched, and thus multiple task data can be switched quickly (more quickly than the data transmission via the bus 60) while maintaining them in a non-volatile manner.

### <Non-Volatile SRAM>

### First Configuration Example

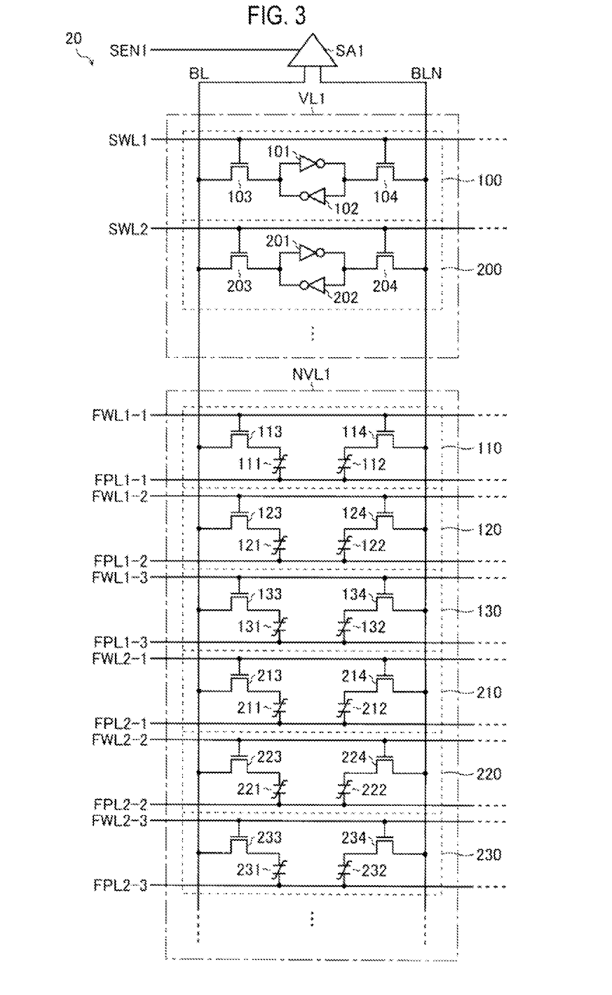

FIG. 3 is a circuit diagram illustrating a first configuration example of the non-volatile SRAM 20. In FIG. 3, SRAMs 100 and 200 are respectively connected to a bit line BL and an inverted bit line BLN of a sense amplifier SA1. FeRAMs 110 to 130 associated with the SRAM 100 and FeRAMs 210 to 230 associated with the SRAM 200 are also respectively connected to the bit line BL and the inverted bit line BLN.

The SRAM 100 includes inverters 101 and 102, and transistors 103 and 104. The inverters 101 and 102 correspond to first and second inverters connected in a loop shape having an input terminal of one inverter being connected to an output terminal of the other inverter. The transistor 103 corresponds to a first switch for connecting/disconnecting between the inverters 101 and 102 and the bit line BL according to a voltage applied to a word line SWL1. The transistor 104 corresponds to a second switch for connecting/disconnecting between the inverters 101 and 102 and the inverted bit line BLN according to the voltage applied to the word line SWL1.

The SRAM 200 has the same configuration as the SRAM 100 with respect to inverters 201, 202 and transistors 203,304. Reference numerals given to the elements of the SRAM 100 are denoted as “10x” (where x=1, 2, 3, 4) and reference numerals given to the elements of the SRAM 200 are denoted as “20x” (where x=1, 2, 3, 4). Reference numeral given to the word line associated with the SRAM 100 is denoted as “SWL1” and reference numeral given to the word line associated with the SRAM 200 is denoted as “SWL2”.

The FeRAM 110 includes ferroelectric capacitors 111 and 112, and transistors 113 and 114. The ferroelectric capacitors 111 and 112 correspond to first and second ferroelectric capacitors connected to a common plate line FPL1-1. The transistor 113 corresponds to a third switch for connecting/disconnecting between the ferroelectric capacitor 111 and the bit line BL according to a voltage applied to a word line FWL1-1. The transistor 114 corresponds to a fourth switch for connecting/disconnecting between the ferroelectric capacitor 112 and the inverted bit line BLN according to the voltage applied to the word line FWL1-1.

The FeRAMs 120 and 130 and the FeRAMs 210 to 230 have the same configuration as the FeRAM 110, except that reference numerals given to the elements of the FeRAM 110 are denoted as “11x” (where x=1, 2, 3, 4) but reference numerals given to the elements of the FeRAM 120, 130, 210, 220 and 230 are denoted as “12x”, “13x”, “21x”, “22x” and “23x” (where x=1, 2, 3, 4), respectively. Reference numeral given to the word line associated with the FeRAM 110 is denoted as“FWL1-1” and reference numerals given to the word lines associated with the FeRAM 120, 130, 210, 220 and 230 are denoted as “FWL1-2”, “FWL1-3”, “FWL2-1”, “FWL2-2” and “FWL2-3”, respectively. Reference numerals given to the plate line associated with the FeRAM 110 is denoted as “FPL1-1” and reference numerals given to the plate lines associated with the FeRAM 120, 130, 210, 220 and 230 are denoted as “FPL1-2”, “FPL1-3”, “FPL2-1”, “FPL2-2”, and “FPL2-3”, respectively.

The sense amplifier SA1 amplifies a potential difference between the bit line BL and the inverted bit line BLN to generate an output signal. The sense amplifier SA1 is enabled or disabled according to a voltage applied to an enable line SEN1.

In the non-volatile SRAM 20 of the first configuration example, the SRAMs 100 and 200 are integrated into a volatile block VL1, and the FeRAMs 110 to 130 and the FeRAMs 210 to 230 are integrated into a non-volatile block NVL1. By employing this layout, pair properties of the SRAMs 100 and 200 and pair properties of the FeRAMs 110 to 130 and 210 to 230 are easily maintained, making it possible to suppress property deviations among them.

Also, in the non-volatile SRAM 20 of the first configuration example, when a non-volatile multi-task function is realized, the non-volatile block NVL1 may be added later so that the volatile block VL1 and the non-volatile block NVL1 share the bit line BL and the inverted bit line BLN, without any additional layout changes in the existing volatile block VL1. This makes the circuit design considerably easier.

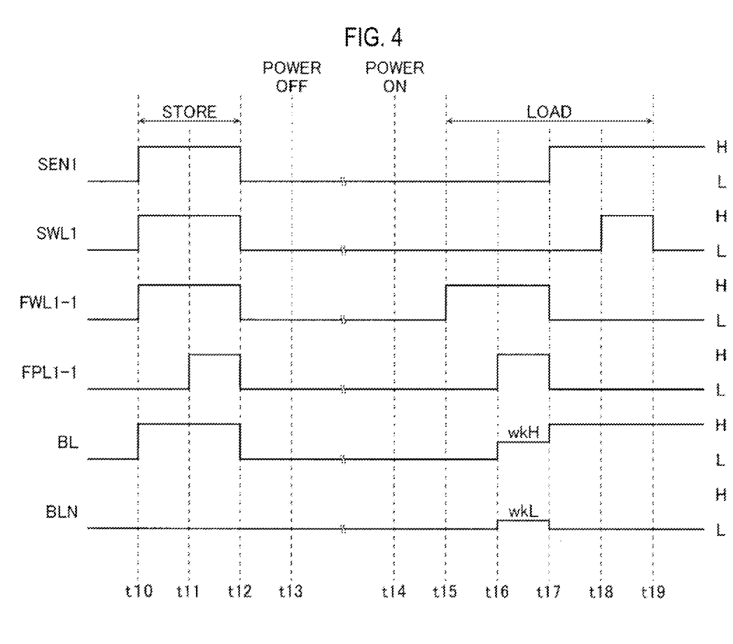

FIG. 4 is a timing chart illustrating a first control example (particularly, storing/reading of the task data using the FeRAM 110) of the non-volatile SRAM 20. Sequentially from top to bottom, voltages respectively applied to the enable line SEN1 of the sense amplifier SA1, the word line SWL1 of the SRAM 100, the word line FWL1-1 and the plate line FPL1-1 of the FeRAM 110, the bit line BL, and the inverted bit line BLN are illustrated. Meanwhile, in FIG. 4, it is assumed that time passes in the order of times t10 to t19.

During time t10 to time t12, the enable line SEN™ is at a high level and thus the sense amplifier SA1 is enabled, and the word lines SWL1 and FWL1-1 are also all at high levels, the transistors 103, 104, 113, and 114 are all tuned on. Therefore, voltages corresponding to the data stored in the SRAM 100 are generated on the bit line BL and the inverted bit line BLN, respectively, and these voltages are applied to the ferroelectric capacitors 111 and 112.

At this point, during time t10 to time t11, the plate line FPL1-1 is at a low level, and during time t11 to time t12, the plate line FPL1-1 is at a high level. In other words, a pulse voltage is applied to the plate line FPL1-1. By this application of the pulse voltage, residual polarization states of the ferroelectric capacitors 111 and 112 are set to one of an inversion state and a non-inversion state.

Specifically, during time t10 to time t12, the bit line BL is at a high level, and the inverted bit line BLN is at a low level. Therefore, during time t10 to time t11, while the plate line FPL1-1 is kept at a low level, no voltage is applied across the ferroelectric capacitor 112 whereas a positive voltage is applied across the ferroelectric capacitor 111. On the other hand, during time t11 to time t12, while the plate line FPL1-1 is kept at a high level, no voltage is applied across the ferroelectric capacitor 111 whereas a negative voltage is applied across the ferroelectric capacitor 112. In this manner, the residual polarization states of the ferroelectric capacitors 111 and 112 have opposite polarities to each other.

At time t12, the enable line SEN1 goes to a low level and thus the sense amplifier SA1 is disabled. Further, the word lines SWL1 and FWL1-1 also all go to a low level, and the transistors 103, 104, 113, and 114 are all tuned off. Therefore, the ferroelectric capacitors 111 and 112 are separated from the bit line BL and the inverted bit line BLN, with the state that their residual polarization states have polarity opposite to each other.

At time t13, the power supply to the non-volatile SRAM 20 is shut off. However, the residual polarization states of the ferroelectric capacitors 111 and 112 are all maintained in previous states before the power is shut off. This corresponds to a state that the data stored in the SRAM 100 is stored in the FeRAM 110.

At time t14, the power supply to the non-volatile SRAM 20 is resumed.

During time t15 to time t17, the word line FWL1-1 is at a high level, with the enable line SEN1 and the word line SWL1 being at a low level, and thus the transistors 113 and 114 are turned on. Therefore, the voltages appearing on one terminals of the ferroelectric capacitors 111 and 112 are applied to the bit line BL and the inverted bit line BLN, respectively.

At this point, during time t15 to time t16, the plate line FPL1-1 is at a low level, and during time t16 to time t17, the plate line FPL1-1 is at a high level. In other words, a pulse voltage is applied to the plate line FPL1-1. By this application of the pulse voltage, voltages corresponding to respective residual polarization states appear on one terminal (further, the bit line BL and the inverted bit line BLN) of the ferroelectric capacitors 111 and 112.

Specifically, a relatively high voltage wkH (weak Hi) appears on one terminal (the bit line BL) of the ferroelectric capacitor 111, and a relatively low voltage wkL (weak Low) appears on one terminal (the inverted bit line BLN) of the ferroelectric capacitor 112. In other words, a difference between voltages corresponding to the residual polarization states of the ferroelectric capacitors 111 and 112 occurs between the bit line BL and the inverted bit line BLN.

At time t17, the enable line SEN1 goes to a high level and thus the sense amplifier SA1 is enabled. As a result, the voltage on the bit line BL increases from the unstable voltage wkH to a stable high level and the voltage on the inverted bit line BLN decreases from the unstable voltage wkH to a stable low level by input and output operations of the sense amplifier SA1.

During time t18 to time t19, the word line SWL1 is at a high level and thus the transistors 103 and 104 are all turned on. At this point, the same voltage as that before the power is shut off is applied to the inverters 101 and 102 from the bit line BL and the inverted bit line BLN. This corresponds to a state that the data stored in the FeRAM 110 is read out to the SRAM 100.

### Second Configuration Example

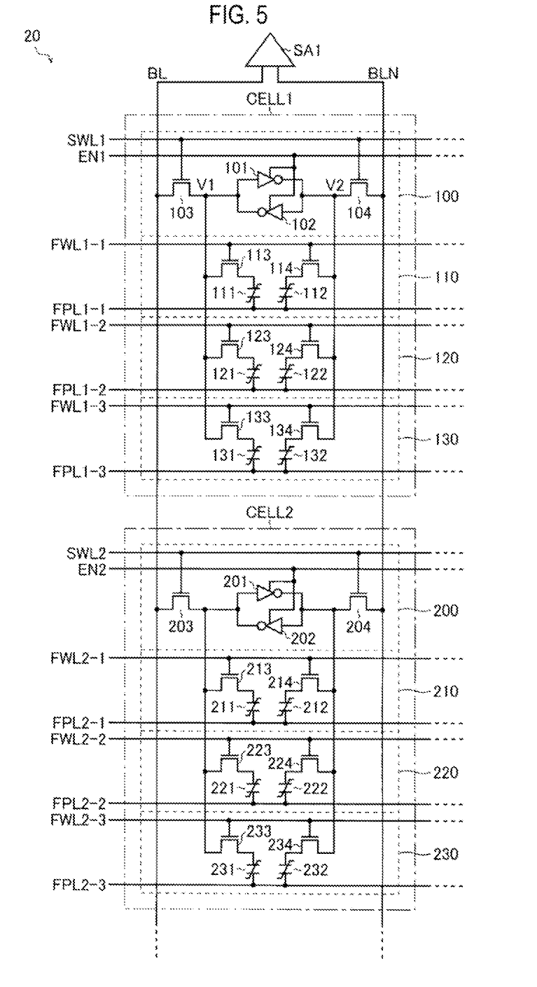

FIG. 5 is a circuit diagram illustrating a second configuration example of the non-volatile SRAM 20. In FIG. 5, SRAMs 100 and 200 are respectively connected to the bit line BL and the inverted bit line BLN of the sense amplifier SA1. FeRAMs 110 to 130 associated with the SRAM 100 and FeRAMs 210 to 230 associated with the SRAM 200 are also respectively connected to the bit line BL and the inverted bit line BLN.

The SRAM 100 includes inverters 101 and 102, and transistors 103 and 104. The inverters 101 and 102 correspond to first and second inverters connected in a loop shape having an input terminal of one inverter being connected to an output terminal of the other inverter. The inverters 101 and 102 are enabled or disabled according to a voltage applied to the enable line EN1. The transistor 103 corresponds to a first switch for connecting/disconnecting between the inverters 101 and 102 and the bit line BL according to a voltage applied to the word line SWL1. The transistor 104 corresponds to a second switch for connecting/disconnecting between the inverters 101 and 102 and the inverted bit line BLN according to the voltage applied to the word line SWL1.

Also, the SRAM 200 has the same configuration as the SRAM 100, except that reference numerals given to the elements of the SRAM 100 are denoted as “10x” (where x=1, 2, 3, 4) but reference numerals given to the elements of the SRAM 200 are denoted as “20x” (where x=1, 2, 3, 4). Reference numeral given to the enable line associated with the SRAM 100 is denoted as “EN1” and reference numeral given to the enable line associated with the SRAM 200 is denoted as to “EN2”. Further, reference numeral given to the word line associated with the SRAM 100 is denoted as “SWL1” and reference numeral given to the word line associated with the SRAM 200 is denoted as to “SWL2”.

The FeRAM 110 includes ferroelectric capacitors 111 and 112, and transistors 113 and 114. The ferroelectric capacitors 111 and 112 correspond to first and second ferroelectric capacitors connected to a common plate line FPL1-1. The transistor 113 corresponds to a third switch for connecting/disconnecting between the ferroelectric capacitor 111 and a node V1 (a connection node of the input terminal of the inverter 101 and the output terminal of the inverter 102) according to a voltage applied to a word line FWL1-1. The transistor 114 corresponds to a fourth switch for connecting/disconnecting between the ferroelectric capacitor 111 and a node V2 (a connection node of the output terminal of the inverter 101 and the input terminal of the inverter 102) according to the voltage applied to the word line FWL1-1.

Also, the FeRAMs 120 and 130, and the FeRAMs 210 to 230 have the same configuration as the FeRAM 110, except that reference numerals given to the elements of the FeRAM 110 are denoted as “11x” (where x=1, 2, 3, 4) but reference numerals given to the elements of the FeRAM 120, 130, 210, 220 and 230 are denoted as “12x”, “13x”, “21x”, “22x” and “23x” (where x=1, 2, 3, 4), respectively. Reference numerals given to the word line associated with the FeRAM 110 is denoted as “FWL1-1” and reference numerals given to the word lines associated with the FeRAM 120, 130, 210, 220 and 230 are denoted as to “FWL1-2”, “FWL1-3”, “FWL2-1”, “FWL2-2” and “FWL2-3”, respectively. Reference numerals given to the plate line associated with the FeRAM 110 is denoted as “FPL1-1” and reference numerals given to the plate lines associated with the FeRAM 120, 130, 210, 220 and 230 are denoted as “FPL1-2”, “FPL1-3”, “FPL2-1”, “FPL2-2”, and “FPL2-3”, respectively.

In the non-volatile SRAM 20 of the second configuration example, the SRAM 100 and the FeRAMs 110 to 130 associated with each other are integrated into a single memory cell CELL1. Similarly, the SRAM 200 and the FeRAMs 210 to 230 are also integrated into a single memory cell CELL2. By employing this layout, a relationship between the SRAMs and the FeRAMs are clearly established.

Also, in the non-volatile SRAM 20 of the second configuration example, when a non-volatile multi-task function is realized, since the storing/reading of task data in/from all the memory cells can be performed at the same time, it is possible to complete higher speed task switching, in comparison with the first configuration example in which the volatile block VL1 and the non-volatile block NVL1 share the bit line BL and the inverted bit line BLN.

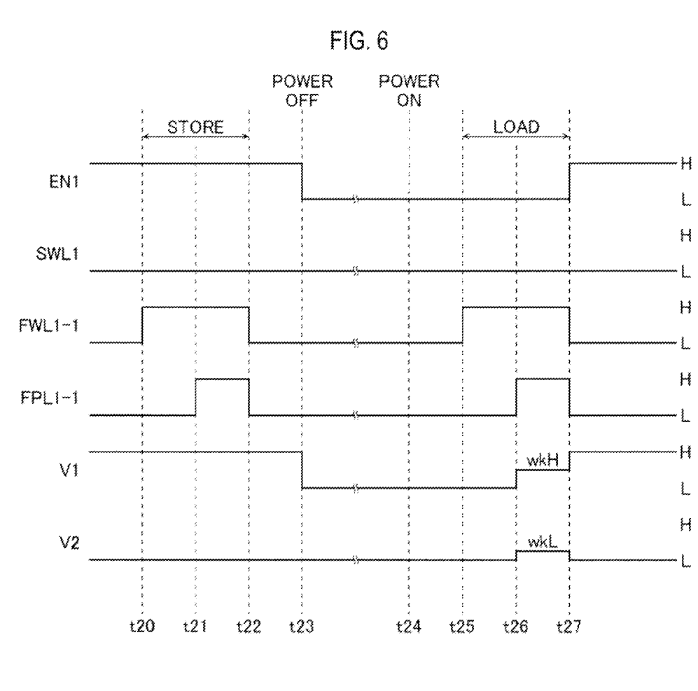

FIG. 6 is a timing chart illustrating a second control example (particularly, storing/reading of task data using the FeRAM 110) of the non-volatile SRAM 20. Sequentially from top to bottom, voltages respectively applied to an enable line EN1 of the inverters 101 and 102, the word line SWL1 of the SRAM 100, the word line FWL1-1 and the plate line FPL1-1 of the FeRAM 110, and the nodes V1 and V2 are illustrated. Meanwhile, in FIG. 6, it is assumed that time passes in the order of times t20 to t27.

While the power is being supplied to the SRAM 100, the enable line EN1 is basically at a high level and thus the inverters 101 and 102 are enabled. Further, the word line SWL1 is at a low level and the transistors 103 and 104 are all turned off as long as the SRAM 100 is not accessed. Therefore, voltages corresponding to the data stored in the SRAM 100 are generated on the nodes V1 and V2, respectively.

During time t20 to time t22, the word line FWL1-1 is at a high level and thus the transistors 113 and 114 are all turned on. Therefore, the voltages on the nodes V1 and V2 are applied to the ferroelectric capacitors 111 and 112 of the FeRAM 110.

At this point, during time t20 to time t21, the plate line FPL1-1 is at a low level, and during time t21 to time t22, the plate line FPL1-1 is at a high level. In other words, a pulse voltage is applied to the plate line FPL1-1. By this application of the pulse voltage, residual polarization states of the ferroelectric capacitors 111 and 112 are set to one of an inversion state and a non-inversion state.

Specifically, during time t20 to time t22, the node V1 is at a high level, and the node V2 is at a low level. Therefore, during time t20 to time t11, while the plate line FPL1-1 is kept at a low level, no voltage is applied across the ferroelectric capacitor 112 whereas a positive voltage is applied across the ferroelectric capacitor 111. During time t21 to time t22, while the plate line FPL1-1 is kept at a high level, no voltage is applied across the ferroelectric capacitor 111 whereas a negative voltage is applied across the ferroelectric capacitor 112. In this manner, the residual polarization states of the ferroelectric capacitors 111 and 112 have opposite polarities to each other.

At time t22, the word line FWL1-1 goes to a low level and thus the transistors 113 and 114 are all tuned off. Therefore, the ferroelectric capacitors 111 and 112 are separated from the nodes V1 and V2, with the state that their residual polarization states have opposite polarity to each other.

At time t23, the power supply to the non-volatile SRAM 20 is shut off. However, the residual polarization states of the ferroelectric capacitors 111 and 112 are all maintained in previous states before the power is shut off. This corresponds to a state that the data stored in the SRAM 100 is stored in the FeRAM 110.

At time t24, the power supply to the non-volatile SRAM 20 is resumed.

During time t25 to time t27, the word line FWL1-1 is at a high level, with the enable line EN1 and the word line SWL1 being at a low level, and thus the transistors 113 and 114 are turned on. Therefore, the voltages appearing on one terminal of the ferroelectric capacitors 111 and 112 are applied to the nodes V1 and V2, respectively.

At this point, during time t25 to time t26, the plate line FPL1-1 is at a low level, and at times t26 and t27, the plate line FPL1-1 is at a high level. In other words, a pulse voltage is applied to the plate line FPL1-1. By this application of the pulse voltage, voltages corresponding to respective residual polarization states appear on one terminals (further, the nodes V1 and V2) of the ferroelectric capacitors 111 and 112.

Specifically, a relatively high voltage wkH (weak High) appears on one terminal (the node V1) of the ferroelectric capacitor 111, and a relatively low voltage wkL (weak Low) appears on one terminal (the node V2) of the ferroelectric capacitor 112. In other words, a difference between voltages corresponding to the residual polarization states of the ferroelectric capacitors 111 and 112 occurs between the nodes V1 and V2.

At time t27, the enable signal EN1 goes to a high level and thus the inverters 101 and 102 are enabled. As a result, the voltage on the node V1 rises from the unstable voltage wkH to a stable high level and the voltage on the node V2 falls from the unstable voltage wkL to a stable low level by the input and output operations of the inverters 101 and 102. In other words, the same voltage as that before the power is shut off is applied to the notes V1 and V2. This corresponds to a state that the data stored in the FeRAM 110 is read out to the SRAM 100.

### <Application to Desk-Top Computer>

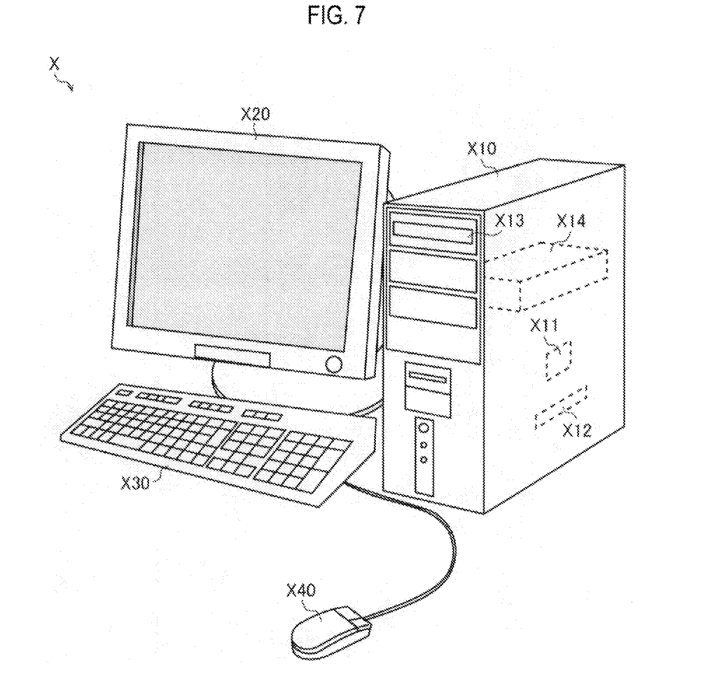

FIG. 7 is an appearance view illustrating one configuration example of a desk-top computer X on which the non-volatile SRAM is mounted. The desk-top computer X of the present configuration example includes a body case X10, a liquid crystal display X20, a keyboard X30, and a mouse X40.

The body case X10 accommodates a central processing unit (CPU) X11, a memory X12, an optical drive X13, a hard disc drive X14, and the like.

The CPU X11 comprehensively controls the operation of the desk-top computer X by executing an operating system or various application programs stored in the hard disc drive X14. Meanwhile, the CPU X11 corresponds to the sequencer 10 of FIG. 1, and has a function of switching and processing multiple task data.

The memory X12 is used as a working area (for example, an area where task data is stored upon execution of a program) of the CPU X11. The non-volatile SRAM 20 of FIG. 1 may be properly used as the memory X12.

The optical drive X13 performs read/write operations of an optical disc. The optical disc may be a compact disc (CD), a digital versatile disc (DVD), a blu-ray disc (BD), or the like.

The hard disc drive X14 is one of large capacity auxiliary storage devices for storing programs or data in a non-volatile manner by using a magnetic disc sealed within a body.

The liquid crystal display X20 outputs a video signal according to an instruction from the CPU X11.

The keyboard X30 and the mouse X40 are any one of human interfaces devices for receiving user's manipulations.

Further, in the above application example, the desk-top computer X is illustrated as one example of the multi-task processing apparatus having the non-volatile SRAM, but the application subject of the present disclosure is not limited thereto and the present disclosure can also be widely applicable to any other the multi-task processing apparatus capable of processing multiple tasks in parallel, such as a notebook, a smart phone, and a tablet.

### <Other Modifications>

Besides the above embodiments, various technical features disclosed in the present disclosure may be variably modified, within the scope that does not depart from the major purpose of the technical creation. For example, the volatile memory cell and the plurality of associated non-volatile memory cells are not limited to a combination of the SRAM and the FeRAMs and a different type of memory cells may be used.

Furthermore, the number of non-volatile memory cells associated with one non-volatile cell is not limited to three, but may be two or four or more.

The present disclosure is applicable to any multi-task processing apparatus such as a desk-top computer, a notebook, a smart phone, and a tablet.

According to the present disclosure in some embodiments, it is possible to provide a multi-task processing apparatus capable of quickly switching the contents of task data, while maintaining the task data in a non-volatile manner.

While certain embodiments have been described, these embodiments have been presented by way of example only, and are not intended to limit the scope of the present disclosure. Indeed, the novel methods and apparatuses described herein may be embodied in a variety of other forms; furthermore, various omissions, substitutions and changes in the form of the embodiments described herein may be made without departing from the spirit of the present disclosure. The accompanying claims and their equivalents are intended to cover such forms or modifications as would fall within the scope and spirit of the present disclosure.

What is claimed is:

1. A multi-task processing apparatus, comprising:
a sequencer configured to switch and process multiple task data; and
a memory configured to store the task data,
wherein the memory is configured to store/read the task data between a volatile memory cell and a plurality of associated non-volatile memory cells when the task data is switched.

2. The apparatus of claim 1, wherein the memory comprises a plurality of pairs of the volatile memory cell and the plurality of associated non-volatile memory cells.

3. The apparatus of claim 2, wherein the memory is configured to return the volatile memory cell to a state before power is shut off, after the power is supplied.

4. The apparatus of claim 1, wherein the volatile memory cell is a static random access memory (SRAM), and the non-volatile memory cells are ferroelectric RAMs (FeRAMs).

5. The apparatus of claim 4, wherein the SRAM comprises:
first and second inverters connected in a loop shape;
a first switch connected between the first and second inverters and a bit line; and
a second switch connected between the first and second inverters and an inverted bit line.

6. The apparatus of claim 5, wherein the FeRAM comprises:
first and second ferroelectric capacitors connected to a common plate line;
a third switch connected between the first ferroelectric capacitor and the bit line; and
a fourth switch connected between the second ferroelectric capacitor and the inverted bit line.

7. The apparatus of claim 6, wherein the SRAM is integrated into a volatile block, and the FeRAM is integrated into a non-volatile block.

8. The apparatus of claim 5, wherein the FeRAM comprises:
first and second ferroelectric capacitors connected to a common plate line;
a third switch connected between the first ferroelectric capacitor and the first and second inverters; and
a fourth switch connected between the second ferroelectric capacitor and the first and second inverters.

9. The apparatus of claim 8, wherein the SRAM and the FeRAMs associated with each other are integrated into a memory cell block.

10. The apparatus of claim 1, wherein the sequencer is a central processing unit.
